(19) United States
(12) Patent Application Publication
(10) Pub. No.: US 2017/0155129 A1
(43) Pub. Date: Jun. 1, 2017

(54) HIGH-ENERGY RECHARGEABLE LITHIUM-SULFUR BATTERIES

(71) Applicant: Indiana University Research and Technology Corporation, Indianapolis, IN (US)

(72) Inventor: Yongzhu Fu, Indianapolis, IN (US)

(73) Assignee: Indiana University Research and Technology Corporation, Indianapolis, IN (US)

(21) Appl. No.: 15/241,761

(22) Filed: Aug. 19, 2016

Related U.S. Application Data
(60) Provisional application No. 62/210,794, filed on Aug. 27, 2015.

(51) Int. Cl. H01M 4/36; H01M 4/38; H01M 4/13; H01M 10/0525; H01M 4/04; H01M 4/62

(52) U.S. Cl. CPC H01M 4/364; H01M 4/0473; H01M 4/622; H01M 4/13; H01M 10/0525; H01M 4/625; H01M 4/38; H01M 2004/028

(57) ABSTRACT

Methods of manufacturing comprising placing a mixture comprising sulfur powder, a carbon nanotube, an alcohol soluble binder, and a solvent into a cast and removing a solvent from the mixture to form an electrode are disclosed. Electrodes and batteries comprising sulfur, a carbon nanotube, and an alcohol soluble binder are also disclosed.

### CROSS-REFERENCE TO RELATED APPLICATIONS

This application claims priority to U.S. Provisional Application Ser. No. 62/210,794, entitled HIGH-ENERGY RECHARGEABLE LITHIUM-SULFUR BATTERIES, filed on Aug. 27, 2015, the entire disclosure of which is hereby expressly incorporated herein by reference.

### GOVERNMENTAL SUPPORT

This invention was made with government support under NNC14CA25C awarded by the National Aeronautics and Space Administration (NASA). The government has certain rights in the invention.

### BACKGROUND

This disclosure relates to electrode fabrication processes for use in rechargeable lithium-sulfur batteries and electrodes fabricated by such methods. More specifically, this disclosure relates to electrode fabrication processes for making sulfur cathodes in rechargeable lithium-sulfur batteries.

Rechargeable batteries play an important role in various electrical systems, such as space flight systems, rovers, exploration vehicles, and astronaut equipment. Smaller, longer-lasting, and safer batteries are often desired, which in some instances may be mission enabling, rather than just mission enhancing. Current Li-ion rechargeable batteries, which currently offer the highest specific energy (Wh/kg) of commercially available secondary batteries, are based predominantly on positive (e.g., LiCoO₂) and negative (e.g., graphitic carbon) intercalation electrodes resulting in practical specific energies of 100-200 Wh/kg for packaged devices. However, some of the energy densities of current Li-ion batteries do not meet the current energy density needed for light-weight power systems for extended duration space missions.

Rechargeable lithium-sulfur (Li—S) batteries are high energy density batteries and typically have high capacities (about 1,672 mAh/g) when sulfur is used as the cathode material. The use of lithium metal with the anode may increase the specific energy of some Li—S batteries to be about 2,600 Wh/kg, which is 3-5 times higher than those of Li-ion batteries. Also, some Li—S batteries may be desirable due to the abundance and environmental benignity of sulfur, and the general low operating voltage of Li—S batteries. In some cases, a low operating voltage may increase the safety of large pack batteries.

However, the sulfur in Li—S batteries undergo a multi-staged reduction reaction to form lithium sulfide (Li₂S) during discharge of the battery, which is converted back to sulfur during charging. Intermediate lithium polysulfides (Li₂Sₓ, 2<x≦8) may form upon cycling, which may be soluble in liquid electrolytes used in Li—S batteries. Because of the electrical properties of these materials, carbon additives may be added to a cathode to change the electrical properties of a rechargeable battery. However, in some instances, the dissolved lithium polysulfides may become inactive and they may shuttle between the cathode and lithium metal anode, which may decrease capacity, cycle life, and Columbic efficiency.

Accordingly, development of advanced sulfur cathodes and Li—S cell configurations may help to advance practical application of Li—S batteries to enable compact power systems.

### SUMMARY

Methods of manufacturing disclosed herein may include placing a mixture comprising sulfur powder, a carbon powder, an alcohol soluble binder, and a solvent into a cast, and removing the solvent from the mixture to form an electrode are disclosed.

Electrodes disclosed herein may include sulfur, a carbon nanotube, and an alcohol soluble binder. Batteries including such electrodes are also disclosed herein.

### BRIEF DESCRIPTION OF THE DRAWINGS

The above-mentioned and other features and objects of this disclosure, and the manner of attaining them, will become more apparent and the disclosure itself will be better understood by reference to the following description of embodiments of the disclosure taken in conjunction with the accompanying drawings, wherein:

FIG. 1 illustrates a battery, and more specifically, a Li—S coin cell according to various embodiments;

FIG. 2 illustrates methods of manufacturing electrodes according to various embodiments;

FIGS. 3A and 3B are scanning electron microscope (SEM) images of sulfur composite electrodes prepared containing PVP;

FIGS. 4A and 4B are scanning electron microscope (SEM) images of conventional sulfur composite electrodes prepared containing PVdF; and

FIG. 5 is a plot of the cycling performance of sulfur composite electrodes according to various embodiments.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates an embodiment of the disclosure, in one form, and such exemplifications are not to be construed as limiting the scope of the disclosure in any manner.

### DETAILED DESCRIPTION

The embodiments disclosed below are not intended to be exhaustive or limit the disclosure to the precise form disclosed in the following detailed description. Rather, the embodiments are chosen and described so that others skilled in the art may utilize its teachings.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

Furthermore, the term “molecular weight” as used herein refers to the weight average molecular weight (W_{M} or WAMW) unless explicitly stated otherwise.

Electrical batteries may comprise two or more electrochemical cells that convert stored chemical energy into electrical energy during discharge and, in some instances, can convert electrical energy into stored chemical energy during recharge. Electrical batteries typically contain a positive electrode (the cathode), a negative electrode (the anode), and electrolytes that allow ions to move between the electrodes, which may permit a current to flow out of the battery.

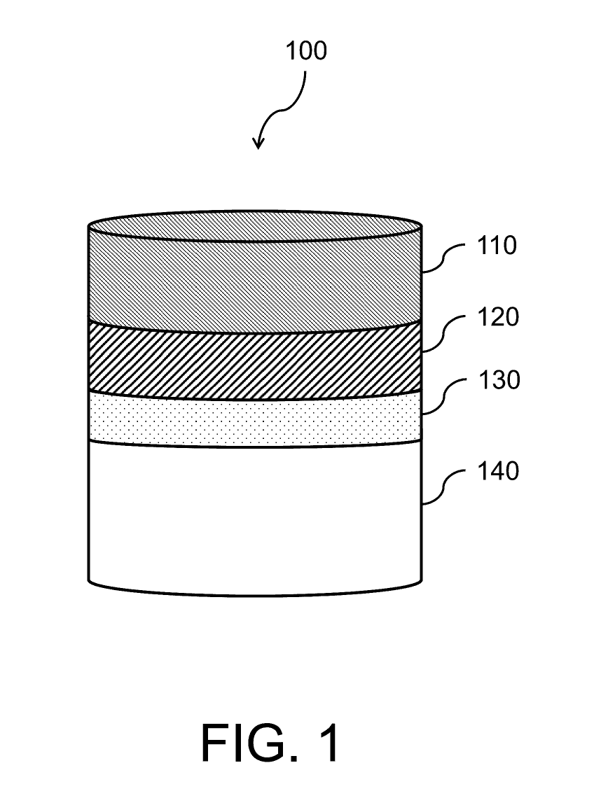

For example, FIG. 1 illustrates a battery according to various embodiments. More specifically, FIG. 1 illustrates a coin cell 100. Coin cell 100 may comprise an anode 110, a separator 120, and a cathode 140. Anode 110 is not particularly limited and may comprise a variety of metals, metal oxides, and metal composites. In addition, coin cell 100 may also comprise an electrolyte which fills pores in the electrodes and separator, and conducts lithium ions between the anode and cathode upon cycling.

For example, anode 110 may comprise lithium, lithium alloys, or metal oxides. Exemplary alloys include Li—Si alloys and Li—Sn alloys. Separator 120 also is not particularly limited and may comprise porous polypropylene. Exemplary separators include CELGARD® 2500 and 2400, commercially available from the Celanese Corporation, a Delaware Corporation. Exemplary separators also include carbon-coated CELGARD® separators. The carbon can be activated carbon, carbon nanotubes, and graphitic carbon. In various embodiments, batteries may also comprise an additional interlayer. For example, coin cell 100 illustrates a coin cell with the optional interlayer 130.

Interlayer 130 may comprise carbon, such as carbon nanotubes (e.g., BuckyPaper). Exemplary commercial interlayers include High Conductivity Multi-Walled Carbon Nanotubes Blended BuckyPaper commercially available from NanoTechLabs, Inc., a North Carolina Corporation.

The electrolyte may comprise organic solvents and lithium salts. Exemplary organic solvents include dimethoxy ethane (DME), 1,3-dioxolane (DOL), diglycol methyl ether (Diglyme), tetraethylene glycol dimethyl ether (Tetraglyme), and tetrahydrofuran (THF). Exemplary salts include lithium trifluoromethanesulfonate (LiCF₃SO₃), lithium bis(trifluoromethane)sulfonamide (LiTFSI), and lithium tetrafluoroborate (LiBF₄). Lithium salts may also include lithium nitrate (LiNO₃) as an additive.

With respect to cathode 140 that forms part of coin cell 100, cathode 140 may comprise sulfur, carbon, and an alcohol soluble binder. In various embodiments the sulfur of cathode 140 may comprise powder sulfur or commercial sublimed sulfur, such as the United States Pharmacopeia (USP) grade sublimed sulfur commercially available from Fischer Chemical, a Delaware Corporation. Various types of carbon suitable for inclusion in an electrode, such as cathode 140, include carbon nanotubes, such as a multi-walled carbon nanotube (MWCNT), single-walled carbon nanotube (SWCNT), TIMCAL C-NERGY Super C65 carbon black, CABOT carbon additives including activated carbon and graphene-based additives, and graphitic carbon.

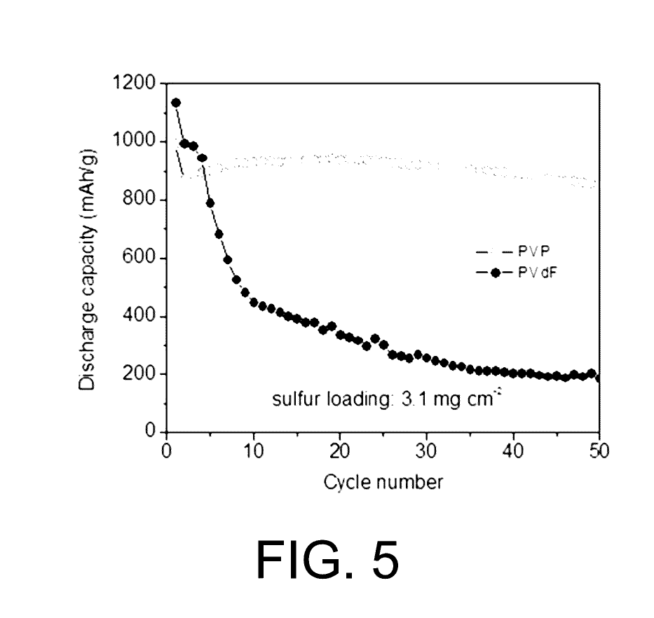

The alcohol soluble binder is not particularly limited and may include a variety of alcohol soluble binders, such as polyvinylpyrrolidone (PVP), a polyamide (e.g., Elvamide®, which is commercially available from DuPont), hyperbranched polymers, and polyurethanes, such as JN-PU-6601A, commercially available from Guangzhou Junneng Chemical Co., Ltd. The solvents used to form the electrodes within the scope of this disclosure are not particularly limited and may include, for example, various types of polar solvents. Exemplary solvents include various alcohols, such as methanol, ethanol, propanol (e.g., isopropanol), butanol, etc. Other suitable solvents may include other polar protic solvents such as acetic acid or nitromethane. Other solvents may include acetone, methyl ethyl keytone (MEK), and tetrahydrofuran (THF). It is believed that the use of certain solvents—such as polar solvents (e.g., alcohols)—may allow for low temperature drying process, which may reduce the sulfur loss during removal of the solvent, may provide for a nontoxic manufacture process, may reduce the manufacture costs of electrodes, and may allow for high performance in batteries. Furthermore, it is believed that the use of various solvents, such as alcohols, may allow for high sulfur loading in various embodiments, as discussed below with reference to FIG. 5.

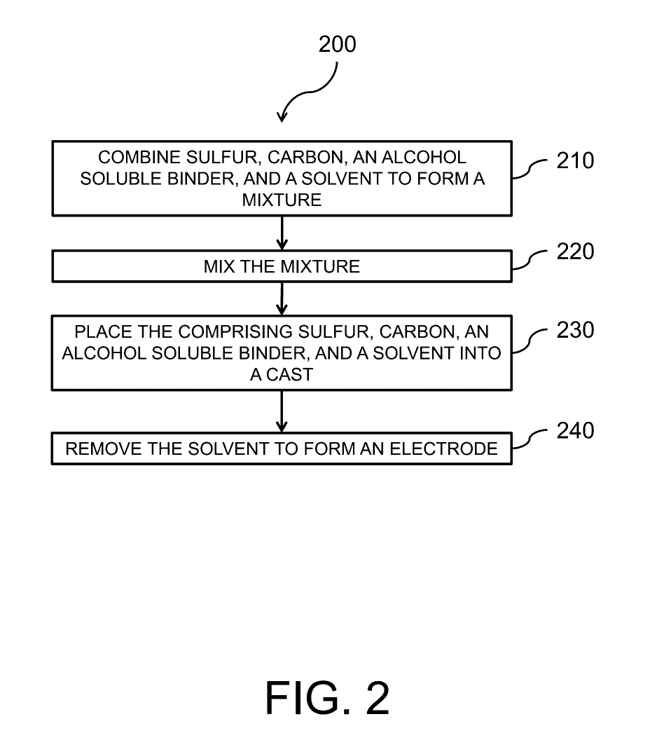

As discussed above, the methods of manufacturing electrodes, such as cathode 140 may affect various properties of the electrode and, thus, batteries incorporating the electrodes. FIG. 2 illustrates method of manufacturing an electrode. Method 200 first comprises combining sulfur powder, carbon nanotubes, an alcohol soluble binder, and a solvent to form a mixture (step 210), and mixing the mixture by magnetic stirring or mechanical stirring (step 220). Then, in some embodiments, the slurry (i.e., the mixture) is placed into a cast, for example, onto an aluminum foil by a doctor blade (step 230). Finally, solvent may be removed (e.g., from the slurry) to form an electrode (step 240). To compare the properties of an electrode made by conventional methods (a control electrode) and an electrode made using an alcohol soluble binder with ethanol were made and their properties were compared.

The control electrode made with sulfur and poly(vinylidene fluoride) (PVdF) as the binder and an electrode prepared by one embodiment of the aforementioned method 200 comprised sulfur were prepared and compared. PVdF was used as a control because PVdF is a widely used binder in electrodes in Li-ion batteries and has been traditionally used in sulfur cathodes in some research reported in relevant literature.

Sulfur Composite Electrode with Poly(Vinylidene Fluoride) Binder (Control Electrode)

A sulfur composite electrode was prepared with poly(vinylidene fluoride) (PVdF) as a binder using an industry-adopted slurry casting method.

A combination of commercially available sublimed sulfur powder, obtained from Fisher Scientific, and multi-walled carbon nanotubes (MWCNT) from Nanostructured & Amorphous Materials, Inc. were mixed well in a mortar. Slurry of the powder mixture and PVdF binder in N-Methyl-2-pyrrolidone (NMP) as the solvent were prepared by magnetic stirring and cast onto an aluminum foil by a doctor blade, and then the electrode was dried in an air oven at 50° C. for 24 hours and yielded the control electrode.

Sulfur Composite Electrodes with Polyvinylpyrrolidone Binder (PVP)

A sulfur composite electrode was also prepared using an embodiment of method 200. First, PVP (Acros Organics, M.W. 1,300,000 M_{w}) was dissolved in ethanol to render a solution with 5 wt. % of PVP. The PVP sulfur composite electrodes were fabricated by the slurry casting method. A combination of commercially available sublimed sulfur powder, obtained from Fisher Scientific, and multi-walled carbon nanotubes (MWCNT) from Nanostructured & Amorphous Materials, Inc. were mixed well in a mortar. Slurry of the powder mixture and PVP binder in ethanol solvent were then prepared by magnetic stirring and cast onto an aluminum foil by a doctor blade. Then the electrode was dried in air at room temperature for over 16 hours.

It was observed that the sulfur composite electrode comprising sulfur powder, MWCNTs, and PVP binder was substantially uniform with active materials and strongly adhered to the aluminum foil. It was found that the sulfur loading of electrodes comprising alcohol binders could be easily adjusted by tuning the gap between the aluminum foil and blade. Suitable sulfur loading of electrodes include values between about 2 mg/cm² and about 10 mg/cm², between about 3 mg/cm² and about 8 mg/cm², and between about 4 mg/cm² and about 6 mg/cm².

For example, FIG. 5 illustrates the discharge capacity (mAh/g) with respect to the cycle number for the control electrode and electrode with PVP binder with a same sulfur loading of 3.1 mg/cm². Both electrodes have same sulfur content (70 wt. %) and MWCNT content (15 wt. %), and a MWCNT-coated separator was used in these cells. As can be seen in FIG. 5, the specific capacity of the control electrode decreases quickly in the first 10 cycles. After 50 cycles, a low specific capacity of only 200 mAh/g can be maintained. In contrast, the electrode with PVP binder shows a relatively stable cycle life with a specific capacity of >800 mAh/g over 50 cycles. The large sulfur particles in microns in the control electrode due to the ineffective dispersion of NMP solvent in the slurry result in uneven current distribution in the cycling, which can make sulfur become inactive upon cycling. The well-dispersed sulfur in the electrode with PVP binder can be effectively utilized, therefore a long cycle life can be retained.

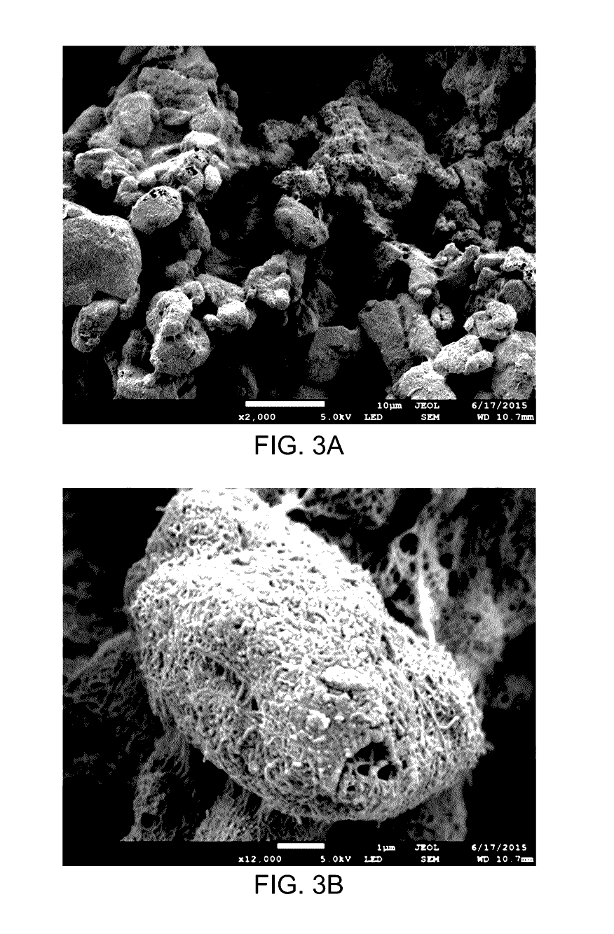

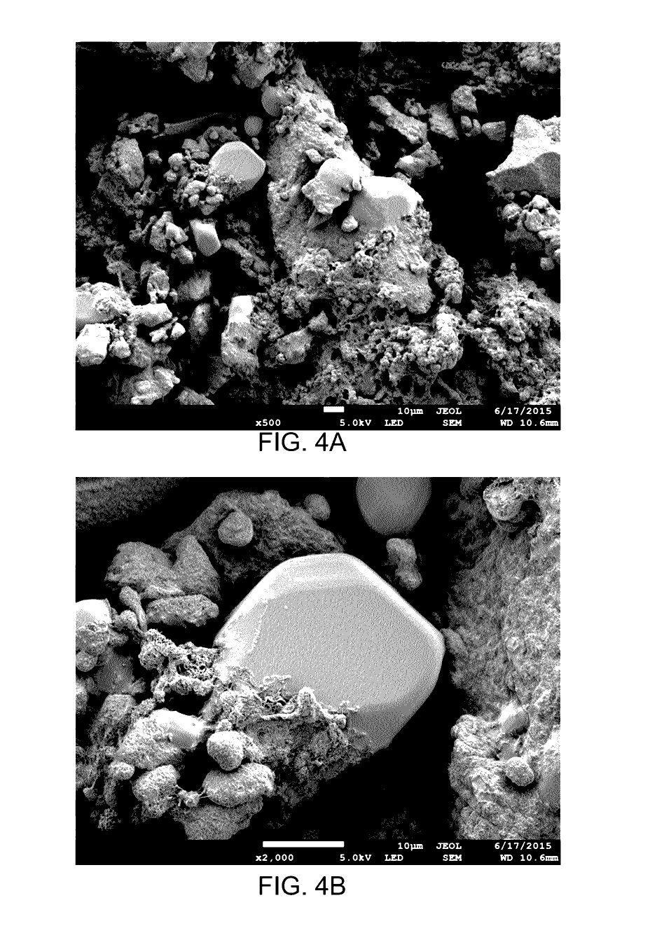

The morphology of the prepared sulfur composite electrodes was observed a JEOL JSM-7800F, a commercially available scanning electron microscope (SEM). The SEM images are shown in FIGS. 3A, 3B, 4A, and 4B, with FIGS. 4A and 4B being SEM images obtained from the control electrode while 3A and 3B being SEM images from the electrode comprising polyvinylpyrrolidone (PVP) (an alcohol soluble binder) where an alcohol (ethanol) was used as the solvent.

As can be seen in FIG. 3A, the electrode comprising an alcohol soluble binder PVP contains particles which consist of well dispersed sulfur in the carbon nanotube network (shown in 3B). All the carbon nanotubes are coated with a thin layer of sulfur. In contrast, the control electrode (shown in 4A) contains large isolated sulfur particles which can be as large as 20 microns. In addition, as can be seen from comparing FIGS. 3A and 4A, the electrode made according to method 200, which comprised an alcohol soluble binder (shown in FIG. 3A) was more porous than the control electrode (shown in FIG. 4A), which was prepared using PVdF and the solvent NMP.

With reference to FIGS. 3B and 4B, FIG. 3B illustrates a single particle in the electrode with MWCNT and PVP and FIG. 4B shows a particle from the electrode comprising MWCNT and PVdF. As can be seen in FIG. 3B, the electrode made in accordance with an embodiment of method 200 had a dispersed network of carbon nanotubes and sulfur. Without being limited to any particular theory, the dispersion of the carbon nanotubes and sulfur in electrodes is believed to be beneficial for electronic and ionic transport.

Furthermore, it is believed that the methods and products disclosed may yield a smaller sulfur particle size within the dispersed network of carbon nanotubes. Average particle size may vary and can be less than 500 nm, between about 1 nm and about 500 nm, between about 5 nm and about 450 nm, between about 50 nm and about 300 nm, and between about 65 nm and 200 nm.

In contrast, the particle from the electrode with MWCNT and PVdF (shown in FIG. 4B) comprises a large sulfur particle partially coated with MWCNTs. Without being limited to any theory, it is believed that larger sulfur particles (e.g., particles greater than 20 μm) may reduce electronic conductance because sulfur is not generally considered a good electronic conductor. Moreover, it is also believed that larger sulfur particles reduce ionic transport due in part to their larger size.

Accordingly, as shown in FIGS. 3A, 3B, 4A, and 4B, the sulfur composite electrode prepared using MWCNT and PVP with ethanol as the solvent yielded a more efficient sulfur cathode than the control electrode that was prepared using MWCNT and PVdF because of the difference in morphology and particle size.

Thus, alcohol soluble binders were identified to be effective and better binders than PVdF. It was also found that PVP has high affinity to polysulfide and lithium sulfide, which can help retain active material in the cathode and reduce shuttle upon cycling in lithium-sulfur batteries.

Furthermore, PVP may be dissolved in polar solvents, such as ethanol, butanol, acetone, etc. Thus, electrodes using certain polar solvents, such as alcohol soluble binders, may be prepared by the slurry method and may be dried at lower temperatures (e.g., below about 100° C., between about −40° C. and about 100° C., between about 0° C. and about 80° C., between about 15° C. and about 75° C., between about 24° C. and about 65° C., about 50° C., or about room temperature), which can minimize sulfur evaporation upon heating. Because PVP may be dissolved in polar solvents, such as alcohol (e.g., ethanol, butanol, and isopropanol)—which result in a low temperature drying process—the loss of sulfur when removing the solvent (e.g., upon heating) may be reduced in various embodiments.

Also, it was found that synthesized sulfur has to be often used when PVdF is used as a binder (because commercial sulfur does not show good performance in PVdF-containing electrodes), this was not the case with electrodes made using alcohol soluble binders according to the embodiments disclosed herein.

It is believed that the use of alcohol soluble binders may simplify the preparation process of large sulfur composite electrodes for large-cell applications. When using an alcohol soluble binder, the resulting electrochemically active sulfur in the electrode may be obtained from additional and cheaper sources of sulfur, such as commercial sulfur. Accordingly, many of the aforementioned benefits may be realized when manufacturing an electrode using the various embodiments within the scope of this disclosure.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the benefits, advantages, solutions to problems, and any elements that may cause any benefit, advantage, or solution to occur or become more pronounced are not to be construed as critical, required, or essential features or elements. Moreover, reference to an element in the singular is not intended to mean “one and only one” unless explicitly so stated, but rather “one or more.” Moreover, where a phrase similar to “at least one of A, B, or C” is used, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C. Different cross-hatching is used throughout the figures to denote different parts but not necessarily to denote the same or different materials.

In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, as used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of manufacturing comprising:
placing a mixture comprising sulfur powder, a carbon powder, an alcohol soluble binder, and a solvent into a cast; and
removing the solvent from the mixture to form an electrode.

2. The method according to claim 1, wherein the alcohol soluble binder can comprise a polyvinylpyrrolidone (PVP), a polyamide, a hyperbranched polymer, a polyurethane, or combinations thereof.

3. The method according to claim 1, wherein the carbon powder comprises a multi-walled carbon nanotube, single-walled carbon nanotube, activated carbon, C-NERGY Super C65 carbon black, CABOT carbon additive, or mixtures thereof.

4. The method according to claim 1, wherein the solvent comprises an alcohol.

5. The method according to claim 1, further comprising sulfur loading the electrode to have an average sulfur loading value between about 2 mg/cm² and about 10 mg/cm².

6. The method according to claim 1, wherein the solvent is a polar solvent.

7. The method according to claim 6, wherein the polar solvent is at least one of ethanol, methanol, propanol, butanol, or acetone.

8. The method according to claim 1, wherein the carbon nanotube is a multi-walled carbon nanotube.

9. The method according to claim 1, wherein the sulfur in the formed electrode has an average particle size between about 1 nm and about 500 nm.

10. The method according to claim 1, wherein the solvent is removed below a temperature of about 100° C.

11. The method according to claim 1, further comprising forming a battery from the electrode.

12. An electrode comprising:
sulfur;
a carbon nanotube; and
an alcohol soluble binder.

13. A battery comprising the electrode of claim 12.

14. The electrode of claim 12, wherein the electrode is formed by removing a solvent from a mixture containing the sulfur, the carbon nanotube, and the alcohol soluble binder.

15. The electrode of claim 12, wherein the electrode is a cathode.

16. The electrode of claim 12, wherein the alcohol soluble binder comprises at least one of a polyvinylpyrrolidone (PVP), a polyamide, a hyperbranched polymer, or a polyurethane.

17. The electrode of claim 14, wherein the solvent is an alcohol.

18. The electrode of claim 17, wherein the alcohol is ethanol.

19. The electrode of claim 12, wherein the sulfur has an average particle size between about 1 nm and about 500 nm.

20. The electrode of claim 14, wherein the solvent is a polar solvent.

21. The electrode of claim 12, wherein the electrode has an average sulfur loading value between about 2 mg/cm² and about 10 mg/cm².
